(19) United States
(12) Patent Application Publication
(10) Pub. No.: US 2005/0114902 A1
(43) Pub. Date: May 26, 2005

(54) Display device with built-in RF control signal receiver

(75) Inventor: Jung-Wan Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/984,909

(22) Filed: Nov. 10, 2004

(30) Foreign Application Priority Data
Nov. 24, 2003 (KR) 10-2003-0083739

(51) Int. Cl. H04N 7/173; H04N 5/44

(52) U.S. Cl. 725/100

(57) ABSTRACT

Provided is a display device with a built-in radio frequency (RF) control signal receiver. The RF control signal receiver is incorporated into a display for displaying the operation and status of an apparatus and receives an RF control signal and delivers the same signal to a master control unit in the apparatus. Conventionally, a display and a RF control signal receiver are separate components. However, the display device is packaged with the built-in RF control signal receiver into a single module, thereby increasing the utilization efficiency of a space on the front of the apparatus. Furthermore, the integral display device and RF integral signal receiver are implemented as a single chip on a printed circuit board (PCB), thereby increasing ease of PCB design.

### CROSS-REFERENCE TO RELATED APPLICATION

This application claims priority under 35 U.S.C. §119(a) from Korean Patent Application No. 10-2003-0083739 filed on Nov. 24, 2003 in the Korean Intellectual Property Office, the entire contents of which are expressly incorporated herein by reference.

### BACKGROUND OF THE INVENTION

1. Field of the Invention

The present invention relates to a display device. More particularly, the present invention relates to a display device with a built-in receiver that receives a radio frequency (RF) control signal.

2. Description of the Related Art

Set-top boxes and other home electronic devices and industrial equipment (hereinafter collectively called “electronic devices”) generally use light emitting diode (LED) displays, vacuum fluorescent displays (VFDs) and liquid crystal display (LCDs) to present the operation and status of the devices. Since most of the electronic devices support remote control functions for user's convenience, the devices have a built-in receiver for receiving a remote control unit's control signal.

Since a remote control unit typically uses an infrared ray (IR) in transmitting a control signal, electronic devices supporting remote control functions require an IR receiver to receive the remote control unit's IR signal. To control another device using information received by the IR receiver, an IR blaster receiver/transmitter (Rx/Tx) that combines the capability of an IR receiver with an IR transmitter may be used.

FIG. 1 is a perspective view of conventional display 110 and IR receiver 120. Referring to FIG. 1, the display 110 and the IR receiver 120 are conventionally separate components. The display 110 is typically attached to the front of an electronic device so that it is highly visible to user's eyes, and the IR receiver 120 is also located on the front of the electronic device to sense a control signal from a remote control unit.

In conventional electronic devices, the display 110 and the short range IR receiver 120 are generally located on the front of the electronic device. As a result, space available on the front of the electronic device for other components (e.g., control buttons and the like) is reduced. Furthermore, a printed circuit board (PCB) needs to be separately designed for the two components.

### SUMMARY OF THE INVENTION

The present invention provides a display device packaged with a radio frequency (RF) control signal receiver in a single chip to increase the utilization efficiency of space on the front of an electronic device.

The above stated object and other objects of the present invention will become readily apparent to one skilled in the art from the following description.

According to an aspect of the present invention, there is provided a display device for displaying the operation and status of an apparatus, the display device having a built-in radio frequency (RF) control signal receiver that receives an RF control signal and delivers the same signal to a master control unit in the apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of conventional display and infrared ray (IR) receiver;

FIG. 2 is a perspective view of a display device with an IR receiver according to an embodiment of the present invention;

FIG. 3 is a front view of a display device according to an embodiment of the present invention;

FIG. 4 shows the internal configuration of the display device of FIG. 3;

FIG. 5 is a front view of a display device with two seven-segment displays according to an embodiment of the present invention; and

FIG. 6 shows the internal configuration of the display device of FIG. 5.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms that will be apparent to those skilled in the art, and should not be construed as being limited to the embodiments set forth herein. Like reference numerals throughout the specification and the drawings denote like elements.

Exemplary embodiments of the present invention will now be described in detail with reference to the accompanying drawings.

Since a remote control unit typically uses infrared ray (IR) in transmitting its control signal, the present invention will be described with reference to an IR receiver as a representative example of a radio frequency (RF) control signal receiver.

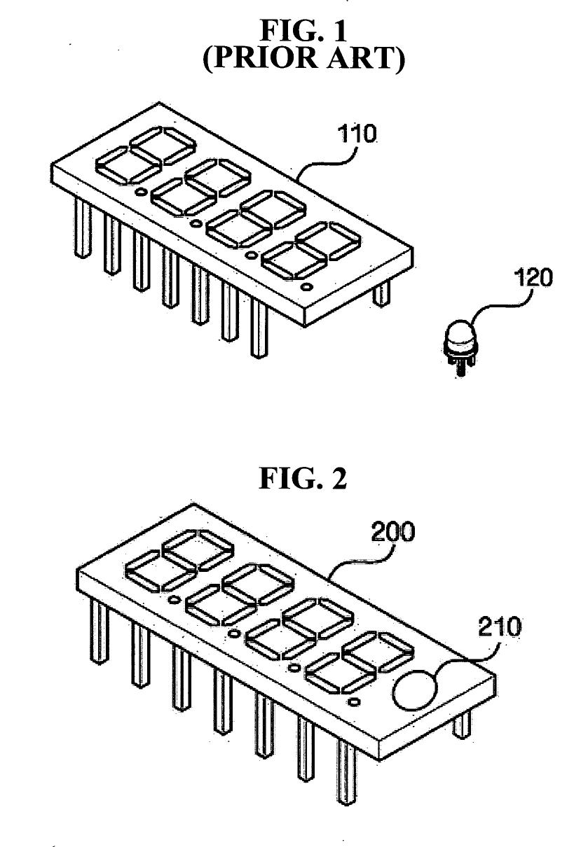

Referring to FIG. 2, an IR receiver is built into a display device 200 according to an embodiment of the present invention. Thus, the present invention allows the display 110 and the IR receiver 120 shown in FIG. 1 to be packaged as a single chip, and hereinafter will be referred to as a “display device”. An IR receiver window 210 is exposed on the surface of the display 200 in order to receive a RF control signal, and the IR receiver is located proximally to, and preferably at the position of the IR receiver window 210.

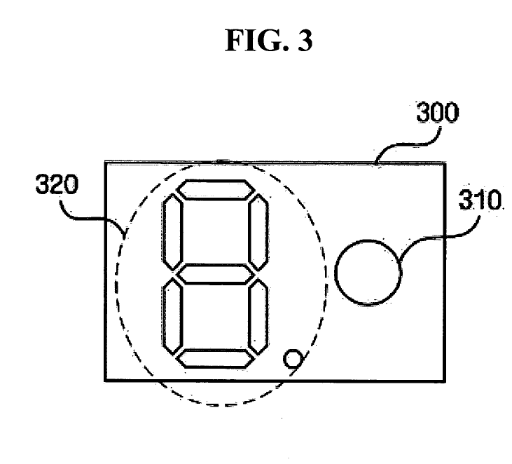

FIG. 3 shows the external front of a display device 300 according to an embodiment of the present invention. The display device 300 includes a seven-segment display 320 with an internal IR receiver packaged as a single chip and an IR receiver window 310 that receives an IR signal.

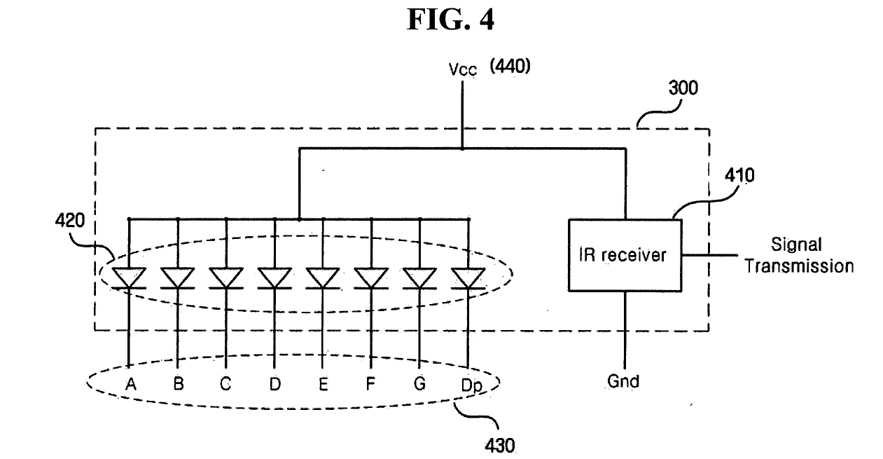

FIG. 4 shows the internal configuration of the display device 300 of FIG. 3. Referring to FIG. 4, the display device 300 includes diodes 420 forming the respective segments of the display 320 and an IR receiver 410 located at the position of the IR receiver window 310. There are two types of seven-segment displays available: common anode and common cathode. The seven-segment display 320 shown in FIG. 4 has a common anode configuration.

When a user sends a control signal with a remote control unit, the IR receiver 410 receives the control signal. The IR receiver 410 then delivers the control signal to a master control unit (MCU, not shown) in the apparatus having the display device 300. The MCU analyzes the control signal from the IR receiver 410, and then controls data through a cathode terminal 430 on each segment, thereby allowing digits or letters to be displayed on the display device 300.

A power supply (Vcc) is required for each light emitting diode (LED) segment 420 in the display 320 to drive the seven-segment display 320 as above. As shown, a Vcc voltage 440 is commonly applied to anode terminals on the LED segments 420 for operation. The IR receiver 410 requires three terminals—Vcc terminal, ground, and terminal used for transmitting the control signal received from the remote control unit. In the illustrative embodiment, the Vcc voltage 440 is commonly applied to the IR receiver 410 and the anode terminals on the diodes 420. In such a manner, the display device 300 and the IR receiver 410 can be packaged as a single component.

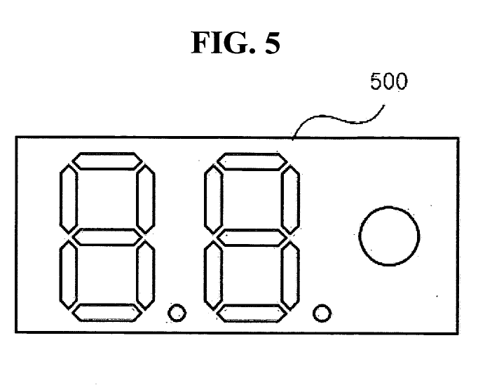

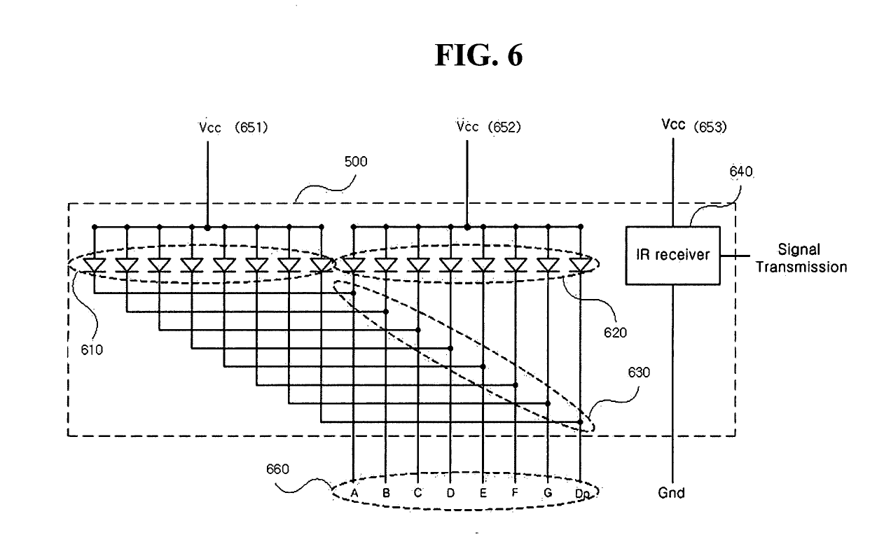

FIG. 5 is a front view of a display device with two seven-segment displays according to an embodiment of the present invention. FIG. 6 shows the internal configuration of the display device 500 of FIG. 5. Referring to FIG. 6, Vcc voltages 651, 652, and 653 are independently applied to diodes 610 and 620 forming the two seven-segment displays and an IR receiver 640, respectively. Terminal A on the diode 610 in one seven-segment display has a connection 630 to terminal A of the diode 620 in the other seven-segment display. The remaining terminals in the one seven-segment display have connections 630 to the counterparts with the same characters in the other display. The MCU applies Vcc voltage 651 or 652 as required to each seven-segment display and controls the data to be displayed on the seven-segment display to which the Vcc voltage 651 or 652 has been applied through cathode terminals 660. In this case, the remaining seven-segment display to which no Vcc voltage 651 or 652 has been applied is unlit. However, alternately applying the Vcc voltage 651 or 652 very quickly makes desired information appear to have been displayed through both seven segment displays. The process of quickly applying current to a display and then turning it off such that it appears to be uniformly lit relies on the afterimage phenomenon of vision. In this instance, alternately turning on two adjacent images with one common control bus saves power, and parts with a nominal increase in processor usage.

If in the embodiment of the present invention shown in FIGS. 5 and 6 the IR receiver 640 shared Vcc with at least one of the two seven-segment displays, normal power could not be supplied to the IR receiver 640 because the Vcc voltage applied to the display is switched. Thus, in order to integrate the IR receiver 640 into the display device 500, a separate Vcc terminal 653 is provided for the IR receiver 640.

In another embodiment of the present invention, when a display has a segment to which a normal power supply Vcc is applied, an IR receiver can be configured such that it shares a Vcc terminal with the segment. For example, in a display for displaying the temperature of an air conditioner as ‘24° C.’, the Arabic numeral ‘24’ represents the temperature of the room and a special symbol ‘° C.’ represents the metric unit of temperature. Since the Arabic numerals vary with the temperature, the Vcc terminal is separately installed for the seven segments that indicate the Arabic numeral ‘24’ to alternately switch a Vcc voltage for input to each terminal. A normal Vcc voltage is needed, however, to indicate the special symbol ‘° C.’. Thus, the segment intended for indicating the symbol shares its Vcc terminal with the IR receiver so that a standby voltage can be applied to the IR receiver. Conversely, when a seven-segment display has a common cathode configuration, each of the seven-segment displays can share a ground terminal with an IR receiver.

Instead of an LED display, a vacuum fluorescent display (VFD) or light commanding diode (LCD) display can be used which share, or not share, a Vcc or ground terminal with the IR receiver. Further, the IR receiver can connect to separate Vcc or ground terminals, so that the IR receiver can be incorporated into the display device.

While a typical IR receiver only functions to receive an IR control signal, an IR blaster for auxiliary remote control combines the capability of an IR receiver with an IR transmitter. The IR blaster amplifies and converts an incoming signal (RF control signal) into an IR format for retransmission to control other electronic products.

The IR blaster may also be designed to have a Vcc terminal or a ground terminal in common with or independently of a display (e.g., LED, VFD, or LCD); Thus, the IR blaster can also be integrated into a display device.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the present invention may be embodied in several forms without departing from the spirit or essential characteristics thereof.

The present invention provides a display device packaged with a RF control signal receiver into a single module, thereby increasing utilization efficiency of a space on the front of an electronic device. Furthermore, since only a single chip is placed on a PCB, it is easy to design the PCB.

1. A display device for displaying the operation and status of an apparatus, the display device comprising:
a display; and
a built-in radio frequency (RF) control signal receiver that receives a RF control signal and delivers the same signal to a master control unit in the apparatus.

2. The device of claim 1, wherein the RF control signal receiver is an infrared ray (IR) receiver.

3. The device of claim 1, wherein the RF control signal receiver comprises a transmitter that amplifies an incoming signal for retransmission to control another apparatus.

4. The device of claim 3, wherein the RF control signal receiver combined with the transmitter is an IR Blaster (Rx/Tx).

5. The device of claim 1, wherein the display is implemented with light emitting diode (LED) segments.

6. The device of claim 3, wherein the display is implemented with light emitting diode (LED) segments.

7. The device of claim 5, wherein the segments have a common anode configuration.

8. The device of claim 5, wherein the segments have a common cathode configuration.

9. The device of claim 6, wherein the segments have a common anode configuration.

10. The device of claim 6, wherein the segments have a common cathode configuration.

11. The device of claim 1, wherein the display is implemented with vacuum fluorescent display (VFD) or liquid crystal display (LCD).

12. The device of claim 1, wherein a common driving voltage is applied to the display and the RF control signal receiver.

13. The device of claim 1, wherein a separate driving voltage is applied to the display and the RF control signal receiver.

14. The device of claim 1, wherein the display shares a common ground terminal with the RF control signal receiver.

15. The device of claim 1, wherein the display and the RF control signal receiver connect to separate ground terminals.

16. The device of claim 1, wherein the display is implemented with vacuum fluorescent display (VFD) or liquid crystal display (LCD).

17. The device of claim 3, wherein a common driving voltage is applied to the display and the RF control signal receiver.

18. The device of claim 3, wherein a separate driving voltage is applied to the display and the RF control signal receiver.

19. The device of claim 3, wherein the display shares a common ground terminal with the RF control signal receiver.

20. The device of claim 3, wherein the display and the RF control signal receiver connect to separate ground terminals.
